(19) United States
(12) Patent Application Publication
(10) Pub. No.: US 2012/0315444 A1
(43) Pub. Date: Dec. 13, 2012

(54) PANEL FRAME STRUCTURE

(75) Inventors: YU-CHOU YEH, TAOYUAN COUNTY (TW); YING-YING LIU, TAOYUAN COUNTY (TW); HSIAO-SHUN JAN, TAOYUAN COUNTY (TW); YUAN-SHENG LIN, TAOYUAN COUNTY (TW)

(73) Assignee: J TOUCH CORPORATION, TAOYUAN COUNTY (TW)

(21) Appl. No.: 13/227,519

(22) Filed: Sep. 8, 2011

(30) Foreign Application Priority Data
Jun. 10, 2011 (TW) 100120349

(51) Int. Cl. B32B 3/02

(52) U.S. Cl. 428/189

(57) ABSTRACT

The present invention discloses a touch panel frame structure comprising: a substrate, made of a transparent insulation material; a sensing layer, formed on a surface of the substrate; a conductor layer, disposed around the periphery of the sensing layer, and electrically coupled to the sensing layer; and an adhesive layer, disposed on a surface of the conductor layer and adhered to the conductor layer between the adhesive layer and the sensing layer, for covering the conductor layer completely. The adhesive layer with a protective coating effect is used for protecting the circuits of the conductor layer from peeling off during use. Particularly, when the substrate is made of a flexible material, the adhesive layer can provide a better protection effect.

### CROSS-REFERENCE TO RELATED APPLICATIONS

This non-provisional application claims priority under 35 U.S.C. §119(a) on Patent Application No(s). 100120349 filed in Taiwan, R.O.C. on Jun. 10, 2011, the entire contents of which are hereby incorporated by reference.

### BACKGROUND OF THE INVENTION

1. Field of the Invention

The present invention generally relates to touch panels, in particular to a touch panel frame structure.

2. Description of the Related Art

As science and technology advance, the application of a touch panel becomes increasingly popular, and present touch panels can be divided into resistive touch panels, capacitive touch panels, a surface acoustic wave (SAW) touch panels according to their sensing principle, and the resistive touch panels and capacitive touch panels are the popular types of touch panels in the market.

The operation of a touch panel adopting the principle of the distribution of an electric field is described as follows. When a user touches the touch panel by a touch pen or the user's finger, the electric field generated by the conductor layer in the touch panel and corresponding to the touch position is electrically converted into a coordination signal, and the coordination signal is used to determine the touch position. Therefore, the design of the conductor layer in the touch panel plays an important role of whether or not the touch panel can determine the touched position accurately.

Now, the capacitive touch panel is used for illustrating the invention, wherein an electric current at the position of a touched point is sensed, and the relation of the current is used to determine the touched position. The conductor layer is provided for compensating the linear distribution of the electric field on the touch panel. In general, the better the linear distribution of the electric field generated by the conductor layer, the more accurate is the determination of the touched position of the touch panel. Since the conductor layer is disposed around the touch panel, therefore the width of the conductor layer will affect the size and range of a usable touch screen. In other words, the larger the conductor layer, the smaller is the area of the touch panel available for the sensing area. Even though the linear distribution of the electric field can be improved by adding more conductor layers, yet the size of the touch panel available for the sensing area becomes smaller, and the manufacturing cost and time of the touch panel will be increased.

In this regard, a Z-shaped electrode is often provided with an insulating area and a gap formed therebetween to improve the linear distribution of an electric field; or a long strip or T-shaped silver wire installed in the gap between the structures is provided to improve and achieve the foregoing expected effect. In addition, a conductor layer formed by a plurality of parallel silver wires and a gap is used to improve the linear distribution of the electric field; or an insulation area defined between the parallel silver wires is provided to improve and achieve the foregoing expected effect.

However, some of the above structures still cannot achieve a stable linear distribution of the electric field around the edges and corners of the touch panel. Therefore, how to effectively take the linear distribution of the electric field of the touch panel into account, reducing the complexity of the conductor layer and the overall width of the conductor layer is a main subject for touch panel designers and manufacturers.

In addition, the fine complicated conductor layer may be cracked or broken easily during the manufacturing process, so that silver wires are generally printed onto a conductive substrate of a touch panel to form the conductor layer, and then an insulating adhesive is coated onto the conductor layer to serve as a protective layer. However, the insulating adhesive may damage the material of the conductor layer easily in a high-temperature and high-moisture manufacturing process. Furthermore, the conductor layer printed on the substrate has a poor adhesiveness and may peel off easily, particularly if the substrate is made of a flexible material.

In view of the aforementioned shortcomings of the prior art, the inventor of the present invention discloses a touch panel frame structure m to overcome the shortcomings of the prior art.

### SUMMARY OF THE INVENTION

Therefore, it is a primary objective of the present invention to provide a touch panel frame structure that covers the surface of the conductor layer completely around the frame by an adhesive layer to achieve the effect of preventing the conductor layer from peeling off during use, and improving the quality of the touch panel significantly.

To achieve the foregoing objective, the present invention provides a touch panel frame structure, comprising: a substrate, made of a transparent insulation material; a sensing layer, formed on a surface of the substrate; a conductor layer, disposed around the periphery of the sensing layer, and electrically coupled to the sensing layer; and an adhesive layer, disposed on a surface of the conductor layer and adhered with the conductor layer between the adhesive layer and the sensing layer, for covering the conductor layer completely.

The present invention uses the adhesive layer to cover the conductor layer completely to prevent the conductor layer at the conventional frame from peeling off after a long time of use. If the adhesive layer and the substrate are made of a flexible material, then the conductor layer and the adhesive layer can be twisted and deformed together with the substrate, when the substrate is twisted and deformed by an external force during use, so as to prevent the twisted and deformed conductor layer from peeling off.

In a preferred embodiment, the substrate of the present invention is made of plastic, polymer plastic, glass or a plastic polymer selected from the collection of resin, polyethylene terephthalate (PET), polycarbonate (PC), polyethylene (PE), polyvinyl chloride (PVC), poly propylene (PP), poly styrene (PS), polymethylmethacrylate (PMMA) and mixtures thereof The sensing layer is composed of an impurity-doped oxide selected from the collection of indium tin oxide (ITO), indium zinc oxide (IZO), al-doped ZnO (AZO) and antimony tin oxide (ATO). The conductor layer is made of a material selected from the collection of chromium, aluminum, silver, molybdenum, copper, gold, high conductive metal and an alloy thereof.

In a preferred embodiment, the sensing layer is manufactured by vacuum sputtering, magnetron sputtering, layer sputtering, spray pyrolysis, pulsed laser coating, arc discharge ion plating, reactive evaporation, ion beam sputtering or chemical vapor deposition, and the sensing layer is disposed on the substrate.

In addition, the adhesive layer of the present invention is made of a transparent curing adhesive, a transparent UV adhesive, a baking type transparent adhesive or a transparent insulating ink. The adhesive layer can also be made of an opaque curing adhesive, an opaque IJV adhesive, a baking type opaque adhesive or an opaque insulating ink. The adhesive concurrent provides the function of the image layer for covering the conductor layer.

In a preferred embodiment, the sensing layer is formed on the whole surface on a side of the substrate, and an image layer is disposed on the sensing layer and corresponding to the periphery of the substrate, and the conductor layer is disposed on the image layer, so that the image layer can cover the conductor layer.

The detailed structure, operating principle and effects of the present invention will now be described in more details hereinafter with reference to the accompanying drawings that show various embodiments of the invention as follows.

### BRIEF DESCRIPTION OF THE DRAWINGS

FIG. 1 is a manufacturing flow chart of a preferred embodiment of the present invention;

FIG. 2 is a schematic perspective view of the preferred embodiment of the present invention;

FIG. 3 is a cross-sectional view of the preferred embodiment of the present invention; and

FIG. 4 is a cross-sectional view of another preferred embodiment of the present invention.

### DETAILED DESCRIPTION OF THE PREFERRED EMBODIMENTS

The technical content of the present invention will become apparent by the detailed description of the following embodiments and the illustration of related drawings as follows.

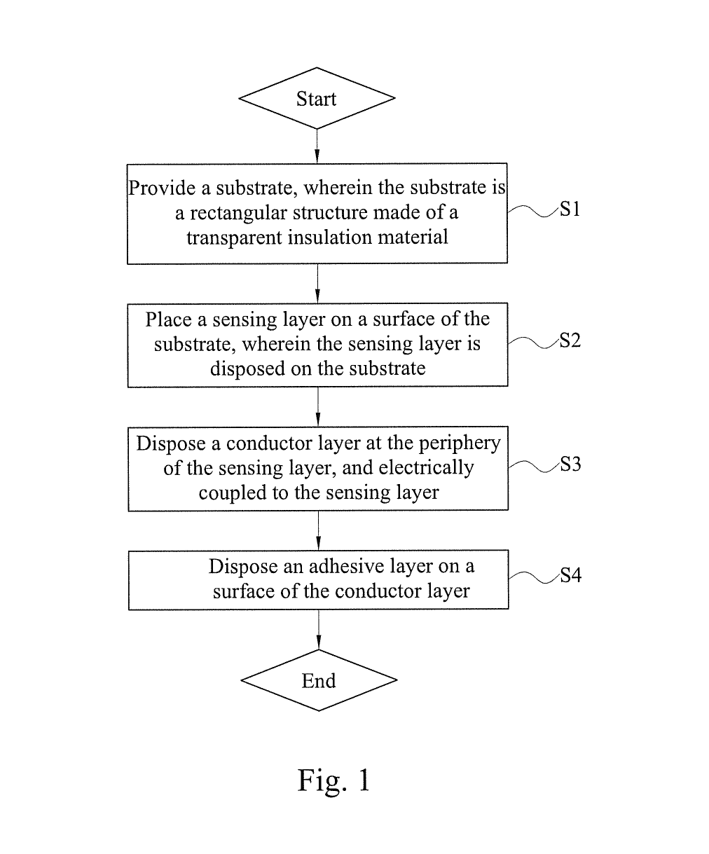

With reference to FIGS. 1, 2 and 3 for a manufacturing flow chart, a perspective view and a cross-sectional view of a preferred embodiment of the present invention respectively, a touch panel frame structure 10 of the present invention is manufactured by the following steps:

In Step (S1), provide a substrate 11, wherein the substrate 11 is a rectangular structure made of a transparent insulation material. The material of the substrate 11 can be plastic, polymer plastic, glass or a plastic polymer selected from the collection of resin, polyethylene terephthalate (PET), polycarbonate (PC), polyethylene (PE), polyvinyl chloride (PVC), poly propylene (PP), poly styrene (PS), polymethylmethacrylate (PMMA), and mixtures thereof, and the substrate is used for carrying the aforementioned components.

In Step (S2), place a sensing layer 12 on a surface of the substrate 11 by vacuum sputtering, magnetron sputtering, layer sputtering, spray pyrolysis, pulsed laser coating, arc discharge ion plating, reactive evaporation, ion beam sputtering or chemical vapor deposition, and the sensing layer 12 is disposed on the substrate 11. The sensing layer 12 is made of an impurity-doped oxide selected from the collection of indium tin oxide (ITO), indium zinc oxide (IZO), al-doped ZnO (AZO) and antimony tin oxide (ATO).

In Step (S3), dispose a conductor layer 13 at the periphery of the sensing layer 12 and electrically coupled to the sensing layer 12, and the conductor layer 13 includes a plurality of conductive wires and electronic components such as capacitors or resistors electrically coupled to the conductor layer 13. The conductor layer 13 is made of a material selected from the collection of chromium, aluminum, silver, molybdenum, copper, gold, high conductive metal and an alloy thereof The electrically conductivity of the conductor layer 13 varies with different metals or alloys.

In Step (S4), dispose an adhesive layer 14 on a surface of the conductor layer 13 by a laminating, coating, printing or spraying method and adhered with the conductor layer 13 between the adhesive layer 14 and the sensing layer 12, so that the adhesive layer 14 is covered by the conductor layer 13 completely to prevent the conductor layer 13 from peeling off during use. The adhesive layer 14 is made of a material selected from the collection of a transparent curing adhesive, a transparent UV adhesive, a baking type transparent adhesive or a transparent insulating ink. In addition, the adhesive layer 14 can also be made of a material from the collection of an opaque curing adhesive, an opaque UV adhesive, an opaque baking type adhesive and an opaque insulating ink to provide the function of the image layer concurrently to cover the conductor layer 13. The aforementioned transparent or opaque adhesive is preferably an UV adhesive to provide a good adhesive effect without damaging the material of the conductor layer.

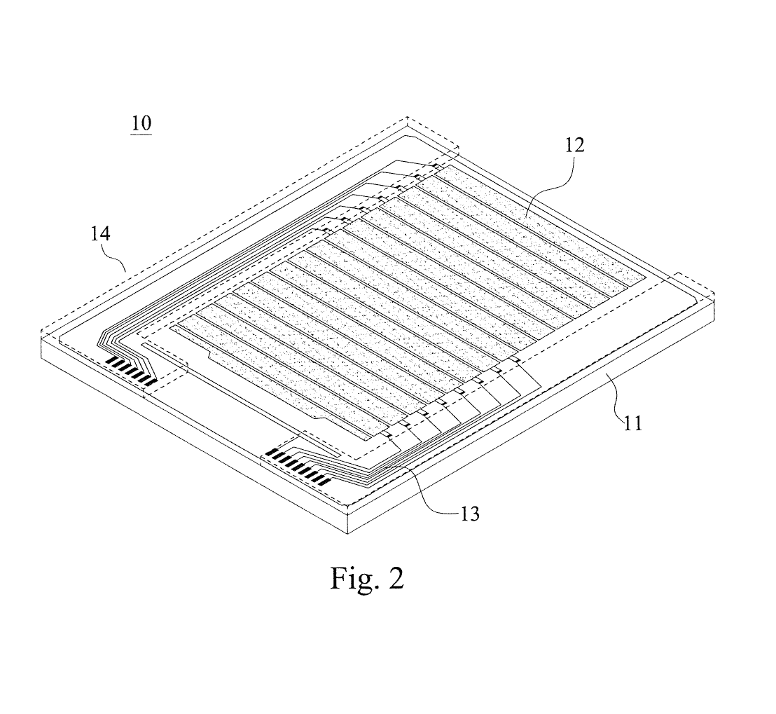

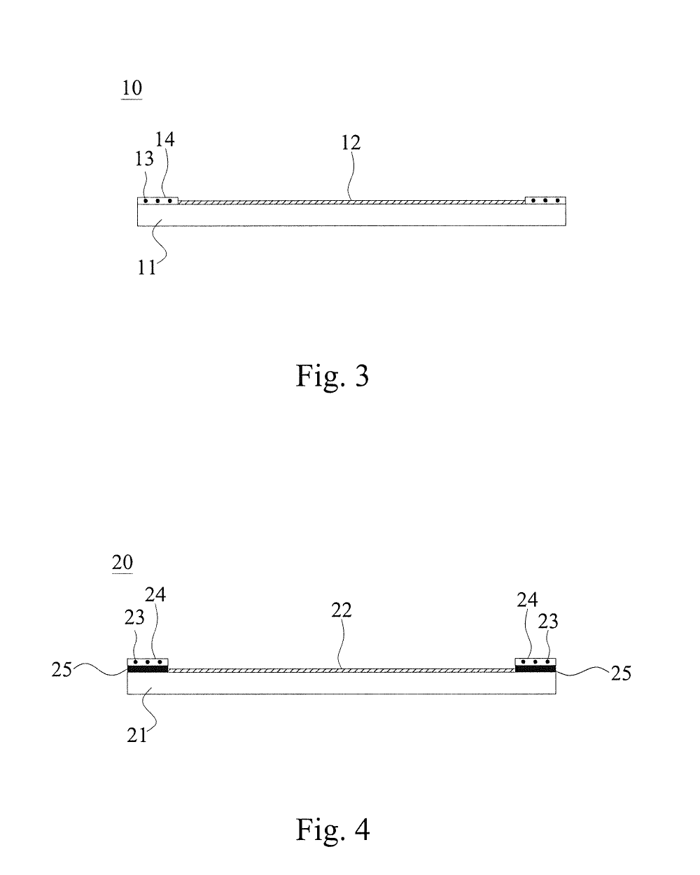

With reference to FIGS. 2 and 3 for a touch panel frame structure 10 manufactured by the aforementioned procedure, the touch panel frame structure 10 includes the substrate 11, wherein the sensing layer 12 is formed at the central position of a surface on a side of the substrate 11, and an interval is formed at the periphery between the sensing layer 12 and the substrate 11, and the conductor layer 13 is disposed at the interval of the substrate 12, and the conductor layer 13 is electrically coupled to the sensing layer 12, and finally the adhesive layer 14 is covered completely onto the conductor layer 13, such that the conductor layer 13 is covered and adhered between the adhesive layer 14 and the sensing layer 12. The insulating property of the adhesive layer 14 can avoid any possible short-circuit occurred during use.

With reference to FIG. 4 for a cross-sectional view of another preferred embodiment of the present invention, a touch panel frame structure 20 of this embodiment also comprises a substrate 21, a sensing layer 22, a conductor layer 23 and an adhesive layer 24. The sensing layer 22 is formed on the whole surface on a side of the substrate 21, and an image layer 25 is disposed around the periphery of the sensing layer 22 and corresponding to the substrate 21 and the image layer 25 is made of an opaque insulating material, and the conductor layer 23 is disposed on the image layer 25. On another side of the substrate 21, the image layer 25 covers the conductor layer 23 completely to form a frame pattern, and finally the adhesive layer 24 is covered completely onto the conductor layer 23, so that the conductor layer 23 can be covered and adhered between the adhesive layer 24 and the image layer 25.

In the foregoing two preferred embodiments, we can observe that the conductor layer 13, 23 of the present invention is covered completely by the adhesive layer 14, 24, and the conductor layer 13, 23 is adhered with the adhesive layer 14, 24 between the sensing layer 12 and the image layer 25, so as to prevent the conductor layer 13, 23 from peeling off after a long time of use. In addition, if the adhesive layers 14, 24 and the substrates 11, 21 are made of a flexible material, the conductor layer 13, 23 and the adhesive layer 14, 24 can be twisted and deformed when the substrate 11, 21 is twisted and deformed during use, so as to prevent the twisted and deformed conductor layers 13, 23 from peeling off.

While the invention has been described by means of specific embodiments, numerous modifications and variations such as the material, shape and size of the substrate, the sensing layer, the conductor layer and the adhesive layer could be made thereto by those skilled in the art without departing from the scope and spirit of the invention set forth in the claims. In summation of the description above, the present invention improves over the prior art and complies with the patent application requirements, and thus is duly file for patent application.

What is claimed is:

1. A touch panel frame structure, comprising:
a substrate, made of a transparent insulation material;
a sensing layer, formed on a surface of the substrate;
a conductor layer, disposed around the periphery of the sensing layer, and electrically coupled to the sensing layer; and
an adhesive layer, disposed on a surface of the conductor layer and adhered to the conductor layer between the adhesive layer and the sensing layer, for covering the conductor layer completely, wherein the adhesive layer is made of a material selected from the collection of a curing adhesive, a UV adhesive, a baking type adhesive and an insulating ink.

2. The touch panel frame structure of claim I, wherein the substrate is made of plastic, polymer plastic, glass or a plastic polymer selected from the collection of resin, polyethylene terephthalate (PET), polycarbonate (PC), polyethylene (PE), polyvinyl chloride (PVC), poly propylene (PP), poly styrene (PS), polymethylmethacrylate (PMMA) and mixtures thereof.

3. The touch panel frame structure of claim 1, wherein the sensing layer is composed of an impurity-doped oxide selected from the collection of indium tin oxide (ITO), indium zinc oxide (IZO), al-doped ZnO (AZO) and antimony tin oxide (ATO).

4. The touch panel frame structure of claim 1, wherein the conductor layer is made of a material selected from the collection of chromium, aluminum, silver, molybdenum, copper, gold, high conductive metal and an alloy thereof.

5. The touch panel frame structure of claim 1, wherein the sensing layer is formed on the whole surface on a side of the substrate, and an image layer is formed on the sensing layer and disposed around the periphery of the corresponding substrate, and the conductor layer is disposed on the image layer, so that the image layer can cover the conductor layer.
